(19) United States
(12) Patent Application Publication
(10) Pub. No.: US 2004/0261318 A1
(43) Pub. Date: Dec. 30, 2004

(54) Sliding door having lateral keeper

(75) Inventors: Curtis L. Berry, Williamsport, MD (US); William B. Nichols, Chambersburg, PA (US)

Correspondence Address: FROST BROWN TODD LLC, 2200 PNC Center, 201 E. Fifth Street, Cincinnati, OH, 45202-4182, US

(73) Assignee: Jamison Door Company

(21) Appl. No.: 10/600,101

(22) Filed: Jun. 20, 2003

(51) Int. Cl. E05D 15/10

(52) U.S. Cl. 49/209

(57) ABSTRACT

A top-supported sliding door system or a vertically sliding door system achieves an enhanced air seal with a lateral keeper mechanism on either or both of the trailing and leading edges. On an outward lateral edge of a door panel, a keeper projects inwardly toward the doorframe to engage a doorframe camming surface such as a pin. The bracket may advantageously disengage under a force indicative of impact in order to minimize damage resulting therefrom. Application of the lateral keeper mechanism may further be used on vertically sliding doors and on multi-panel horizontal sliding doors. In addition, a rail may extend from the angled pin to engage the keeper throughout the full travel of the door panel.

### FIELD OF THE INVENTION

The present invention relates, in general, to sliding doors. and more particularly to doors suitable for cold storage rooms.

### BACKGROUND OF THE INVENTION

Sliding doors typically move horizontally or vertically and parallel to the wall to which they are attached along a track system. In some applications the door may move away from the wall on a track system once it has cleared the opening as in an overhead door or a vertical door that is tilted out from the wall. The door panel may be manually or automatically moved from its blocking position to an unblocking position. Some door openings may use multiple leaves to cover the opening. In horizontal applications the leaves will move in opposite directions to clear the opening more quickly. In some instances, the amount of overhead track required to extend beyond the door opening is reduced by having the door panel vertically divided into a number of over-lapped vertically-separated leaves that take up less horizontal space when moved to the unblocking position.

Cold storage lockers are often accessed through a door opening closed by a sliding door. The panels for this purpose are typically transparent vinyl sheets, minimally insulated flexible panels or foam filled rigid panels. The transparent vinyl sheets are selected to reduce the likelihood of damage to the door. In particular, such doors arc used in institutional (e.g, warehouse) setting wherein palletized cargo is moved in and out of a cold storage locker by forklift. Since this panel is transparent, it also allows forklift operators to see what is on the other side of the door before it is opened. Although providing damage resistance, these types of panels have a very low insulation value and are too flexible to provide an effective air seal between the environments on either side of the opening. Because of the properties of the material, the transparent vinyl sheets may develop a warp that prevents a good seal. Air pressure differentials will cause leakage due to the lack of a compressive seal between the door panels and the doorframe. This will allow a significant amount of warm moist air to enter the cold storage locker and/or refrigerated air to be lost into an unrefrigerated space. Consequently, such door systems are less efficient to operate and can lead to ice accumulation in the cold storage locker.

Rigid door panels are often used, especially in the United States, in order to reduce the operating costs of a cold storage locker. The rigid panel provides a consistent surface to seal to the doorframe. The thickness of the rigid door panel is selected to provide a specific amount of insulation. Since the panel is rigid a constraint can be applied to the edges that are parallel to tine direction of travel to seal the door against the gasket the full width of the panel perpendicular to the direction of travel. On a horizontal sliding door the constraint is a floor-mounted device that presses against the door when it is closed. Typically these devices are rollers that are bolted to the floor and, since they are rigidly mounted, they can be damaged or broken when the door is impacted and/or they cause damage to the panel during an impact Elimination of the need for these items would reduce the amount of damage to a rigid panel during an impact Rigid door panels do provide very good environmental separation; however the panels become susceptible to differential air pressure defeating the air seal.

Vertical sliding doors, similar to the familiar residential garage door, are supported on both vertical sides. However, these doors can also suffer to a degree from a poor seal at the top lateral and/or bottom lateral edges, especially for a wide doorway. It would be desirable to also provide a way to urge these non-tracked edges into scaling contact with the door front.

Attempts have been made to provide a damage resistant door panel for a sliding door system that also provides sufficient insulation. Resilient door panels have been suggested which have sufficient thickness to insulate like a rigid door panel, but yield to a degree when impacted by a forklift while the panel itself achieves a degree of insulation, the insulation capability of the overall door system suffers from poor sealing between panels and poor sealing between a panel and the doorframe. The stiffness of each door panel is much less than that of a rigid panel so scaling across the frill gasket width perpendicular to the direction of travel is very difficult.

Consequently, a significant need exists for an improved sealing system for sliding doors that maintains a good air seal to the doorframe It would be desirable in some instances that the improved sealing system be releasable and easily resets. This will minimize damage of rigid panels and will improve the seal of flexible panels.

### BRIEF SUMMARY OF THE INVENTION

The invention overcomes the above-noted and other deficiencies of the prior art by providing a sliding door system that achieves a good seal to a doorframe with a lateral keeper on a lateral edge of each door panel that is pulled into a camming surface on the doorframe. Thereby, warping of the door panel or an air pressure differential is overcome that may prevent a good seal. Moreover, this lateral keeper advantageously improves both rigid door panels as well as resilient door panels.

In one aspect of the invention, a first engagement device is on a vertical lateral surface of a horizontally sliding door panel, one that is not supported by a door track This first keeper projects toward the doorframe to engage a second keeper that projects toward the door panel and that is recessed from a sealing surface of the doorframe. These keepers slidingly engage with one another as the door panel closes to urge the door panel against the sealing surface of the doorframe. Thereby, the door panel resists material warping or air pressure differentials that would otherwise impair a good sealing contact.

These and other objects and advantages of the present invention shall be made apparent from the accompanying drawings and the description thereof.

### BRIEF DESCRIPTION OF THE FIGS

The accompanying drawings which are incorporated in and constitute a part of this specification, illustrate embodiments of the invention, and, together with the general description of the invention given above, and the detailed description of the embodiments given below, serve to explain the principles of the present invention.

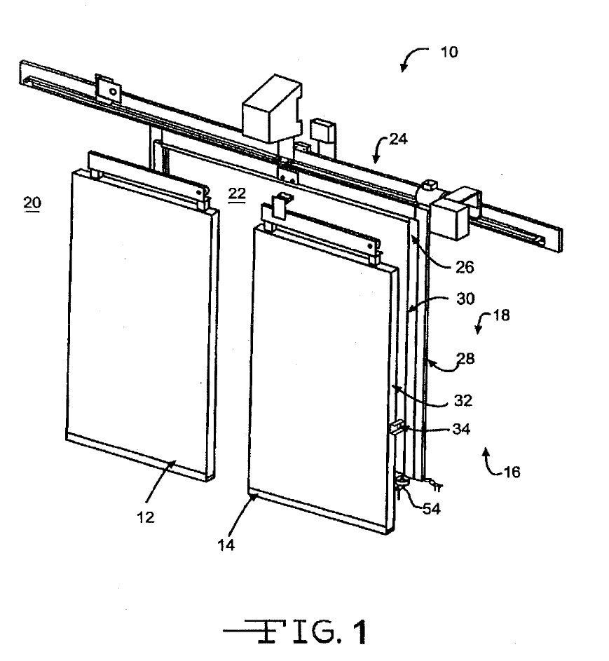

FIG. 1 is front exploded perspective view of a door system for an institutional cold storage locker.

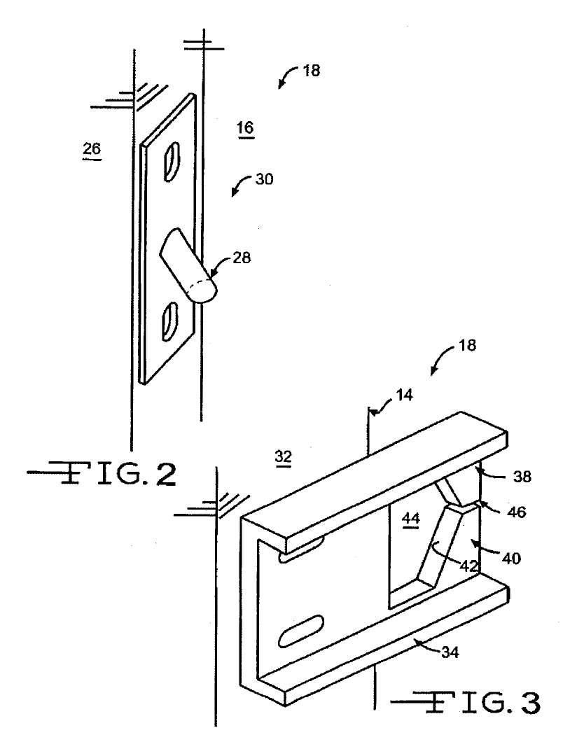

FIG. 2 is a top front perspective view of a doorframe pin of the door system of FIG. 1 .

FIG. 3 is a front perspective view of a door panel releasable lateral keeper of the door system of FIG. 1.

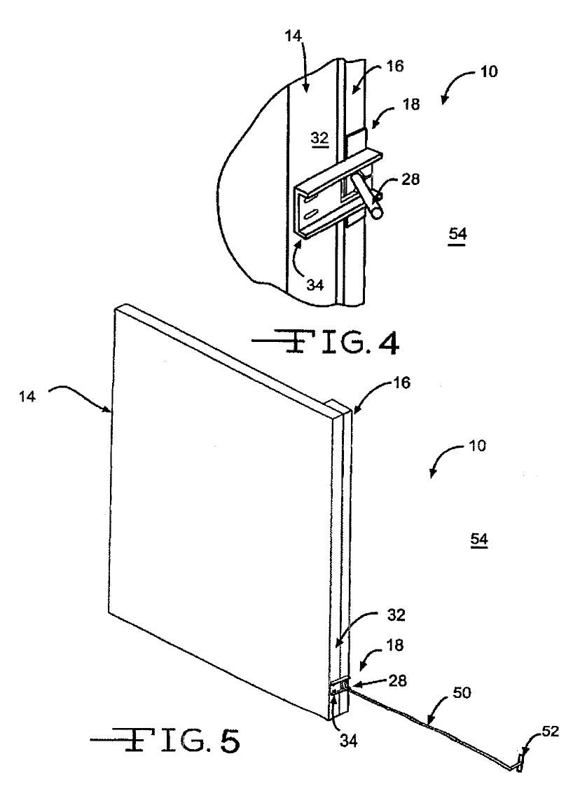

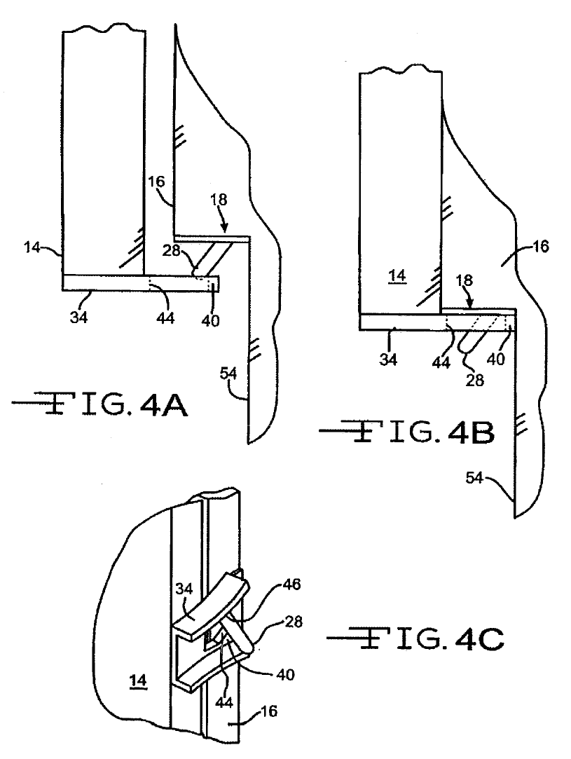

FIG. 4 is a front perspective view of the releasable lateral keeper engaging the doorframe pin of the door system of FIG. 1.

FIGS. 4A-4B are top views of the releasable lateral keeper engaging and then fully engaged to the door frame pin of the coor system of FIG, 1.

FIG. 4C is a too front perspective view of the door panel releasable lateral keeper of FIG. 4 deforming due to door impact

FIG. 5 is front perspective view of a sliding door system for an institutional cold storage locker incorporating a full-travel lateral keeper.

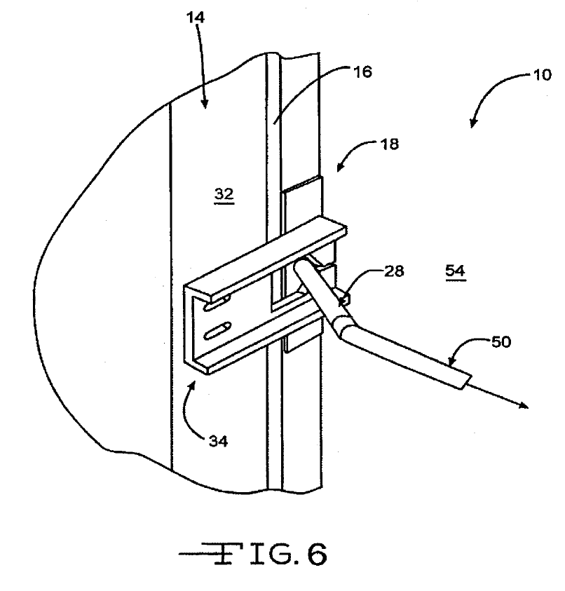

FIG. 6 a detail view of a door panel coupling to the full-travel lateral keeper.

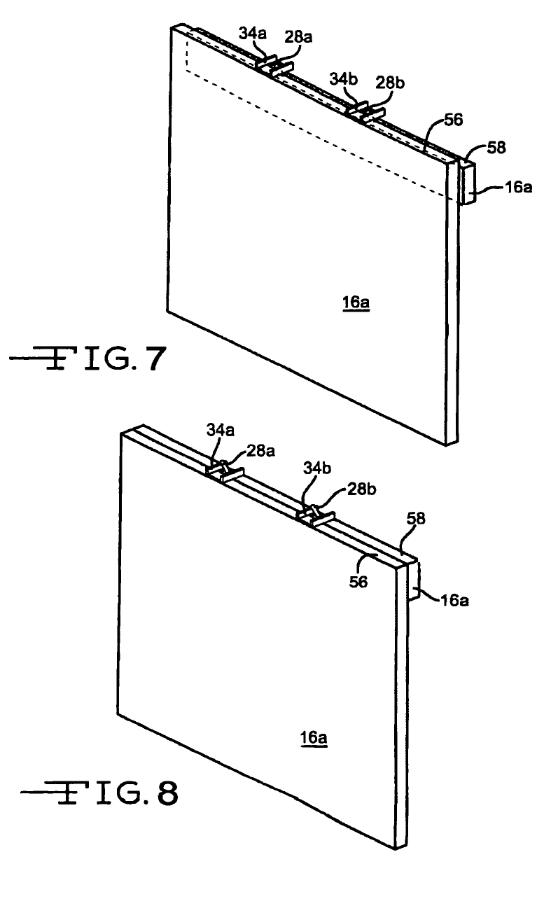

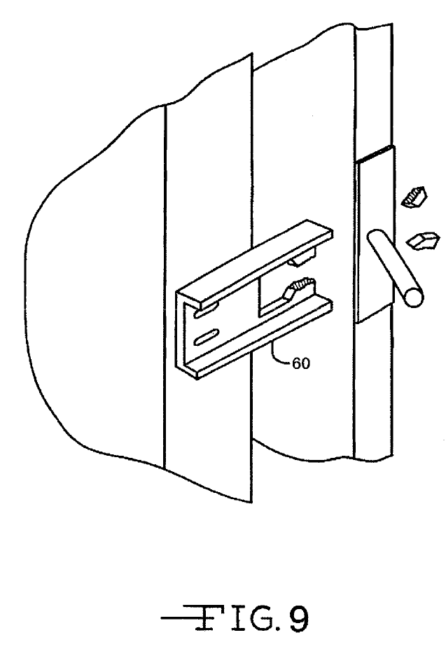

FIGS. 7-8 are ton front perspective views of door panel releasable lateral keepers used on a vertically translating door panel.

FIG. 9 is a perspective view of a frangible lateral keeper releasing the keeper pin due to door impact.

### DETAILED DESCRIPTION OF THE INVENTION

A sliding door system achieves a good seal to a doorframe with a lateral keeper on a trailing edge of a door panel that is pulled into a camming surface on the doorframe for bi-parting doors. For single door panels a camming surface is also provided on the leading edge of the panel and a keeper is provided on the doorframe.

The system mechanically pulls the door into the gasket overcoming leaks in the seal that can be created by warping of the door panel or an air pressure differential and advantageously improves the scat of both rigid door panels and resilient door panels.

The term “lateral” used herein refers to a door panel edge, in tither a horizontally or vertically sliding door system, that is traverse to the direction of open and closing A leading edge is a lateral edge that is foremost during closing and a trailing edge is rearmost during closing.

Turning to the Drawings wherein like numbers denote like components throughout the several views, in FIG. 1, a closure system, depicted as a bi-parting horizontal sliding door system 10, advantageously includes door panels 12, 14 that are affirmatively sealed to a doorframe 16 by a lateral keeper mechanism 18 to effectively separate a warm space 20 from a cold space 22 (e.g., a cold storage locker). As shown particularly in FIG. 1. the door panels 12, 14 are supported by and power actuated by an overhead carriage 24, as is generally understood by those skilled in the art.

Recessed back from a sealing surface 26 of the doorframe 16, a camming surface, depicted as a keeper pin 28, is mounted laterally outward from a vertical portion 30 of the sealing surface 26. The keeper pin 28 is shown in greater detail in FIG. 2.

Returning to FIG. 1, a vertical lateral edge 32 of the door panel 14 is shown as having a corresponding engagement device, depicted as a keeper 34, shown in greater detail in FIG. 3. The keeper 34 forms a female catch surface that projects toward the doorframe 16 to capture the keeper pin 28 as the door panel 14 nears a closed position, thereby urging the door panel 14 into sealing contact with the doorframe 16, as depicted in FIG. 4.

It will be appreciated that, alternatively, a camming surface may be incorporated into a door panel with a keeper affixed to a doorframe. Furthermore, although the keeper pin 28 is recessed by having the sealing surface 26 spaced outward from the doorframe 16, alternatively a keeper pin may be recessed into a channel (not shown) sized to receive a projecting portion of the keeper of the door panel so that the keeper of the door does not abrade the wall during opening and closing

With particular reference to FIG. 3, the keeper 34 is shown to advantageously include a deformable or resilient characteristic that is responsive to an abnormal load from an impact. Specifically, an upper finger 38 meets a lower finger 40 to form an engaging surface 42 for camming against the keeper pin 28. An aperture 44 formed therebetween is sized to receive the keeper pin 28 should the door panel 14 be initially spaced away from the doorframe 16, as shown in FIGS. 4A-4B. The aperture 44 advantageously converges toward a split 46 between the upper and lower fingers 38, 40 to direct an impact force thereto. as shown in FIG. 4C.

With regard to FIGS. 5-6, an additional feature is depicted by including an extension member, depicted as a rail 50, is connected to the keeper pin 28 and positioned parallel to the wall and floor to remain engaged to the keeper 34 during the full travel of the door panel 14. An outer end of the rail 50 transitions to an outer bracket 52 attached to a wall 54 or to the floor. Typically, the outer bracket 52 is further away from the doorway than the keeper 34 traverses during opening and closing Therefore, other devices such as a stay roller (shown at 54 in FIG. 1) are not necessary to prevent a significant draft through the doorway from preventing proper operation. A device is usually required on the floor because air pressure on the back of the door can swing push it far enough away from the wall that the keeper 34 to grab the keeper pin 14. However, the additional outward resistance offered by such a device as a stay roller may tend to allow additional damage to occur to the door when impacted. Alternatively, the door panel 14 may suffer from additional wear due to continued contact with the stay roller.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, in the illustrative embodiment, the keeper 34 is advantageously formed from a polymer in order to provide lubricity and the desired resiliency, and the keeper pin 28 is formed from metal for strength However, either may be formed from a metal, a polymer, a composite material, etc.

As another example, it will be appreciated tat the capability for disengaging in response to an impact force may be omitted in applications such as a rigid door panel such as shown in FIGS. 7-8 for a rigid. vertically translating door panel 169 having two keepers 349,346 spaced on a top trailing edge 25 to capture respective keeper pins 28a, 28b on a ton edge 58 of door frame 16a. Moreover, instead of a resiliently engaging device with a preformed split 46, a frangible keeper may be used consistent with aspects of the invention whereby the keeper is replaced after an impact. Alternatively, the keeper pin 28 may be selected to resiliently yield or to fracture under impact loads.

What is claimed is:

1. A door system, comprising:
a doorframe defining an entrance and having a sealing surface;
a door track mounted across a top portion of the doorframe;
a door panel supported by the door track for movement between an open position
and a closed position with the sealing surface of the doorframe; and
a first engagement device on a vertical lateral surface of the door panel, projecting
toward the doorframe; and
a second engagement device projecting toward the door panel and recessed from
the sealing surface of the doorframe, the first and second engagement
devices adapted to slidingly engage during closing of the door panel and to
urge the vertical lateral surface of the door panel toward the sealing
surface of the doorframe.

2. The door system of claim 1, wherein a selected one of the first and second engagement devices comprises a deformable device adapted to disengage from the other engagement device in response to an impact to the door panel.

3. The door system of claim 1, wherein the first engagement device comprises a female catch member and the second keeper device comprises a camming surface.

4. The door system of claim 3, wherein the female catch member comprises a keeper and the camming surface comprises an angled post.

5. The door system of claim 4, wherein the keeper includes a split engaging surface registered to the camming surface and having an upper member and lower member adapted to resiliently separate in response to an impact force.

6. The door system of claim 5, wherein the camming surface further comprises a rail extending outward aligned with travel of the keeper during opening and closing of the door panel.

7. The door system of claim 1, wherein the first keeper device is on a trailing edge of the door panel, the door system further comprising:
an opposing door panel supported by the door track for opposing movement to the
door panel between an open position and a closed position with the sealing
surface of the doorframe, the two door panels sized to together close the
entrance;
another set of first and second keeper devices configured to urge a trailing edge of
the opposing door panel toward the sealing surface of the doorframe.

8. A door system, comprising:
a doorframe defining an entrance and having a sealing surface;
a door track mounted on the doorframe;
a door panel supported by the door track for movement between an open position
and a closed position with the sealing surface of the doorframe;
a first keeper device on a lateral surface of the door panel, projecting toward the
doorframe; and
a second keeper device projecting toward the door panel and recessed from the
sealing surface of the doorframe, the first and second keeper devices
adapted to slidingly engage during closing of the door panel and to urge
the lateral surface of the door panel toward the sealing surface of the
doorframe.

9. The door system of claim 8, wherein the second keeper device is on a leading edge of the door panel.

10. The door system of claim 8, wherein the door track guides the door panel vertically downward to close the door panel.

11. The door system of claim 8, wherein the door rail guides the door panel horizontally to close the door panel.

12. A door system, comprising:
a doorframe defining an entrance and having a sealing surface;
a door track mounted on the doorframe;
a door panel supported by the door track for movement between an open position
and a closed position with the sealing surface of the doorframe; and
a lateral keeper means for urging the door panel into sealing contact with the
doorframe during closing.

13. The door system of claim 12, further comprising a keeper release means for disengaging the lateral keeper means in response to an impact to the door panel.

14. The door system of claim 12, further comprising a rail means for maintaining engagement of the lateral keeper means during movement of the door panel.
